(19) United States
(12) Patent Application Publication
(10) Pub. No.: US 2026/0333244 A1
(43) Pub. Date: Oct. 22, 2026

(54) RESTRICTION ON EMISSION OF RADIO WAVE FROM COMMUNICATION TERMINAL

(71) Applicant: Rakuten Mobile, Inc., Tokyo (JP)

(72) Inventors: Makoto ONO, Tokyo (JP); Bingxuan ZHAO, Tokyo (JP); Warangrat WIRIYA, Tokyo (JP); Ryusuke UTSUNOMIYA, Tokyo (JP); Hyungmin HA, Tokyo (JP); Ryoji OSAKA, Tokyo (JP)

(21) Appl. No.: 19/270,478

(22) Filed: Jul. 16, 2025

(30) Foreign Application Priority Data
Apr. 17, 2025 (JP) 2025-068437

(51) Int. Cl. H04W 52/28; H04W 52/36

(52) U.S. Cl. CPC H04W 52/283; H04W 52/282; H04W 52/367

(57) ABSTRACT

A determiner determines whether a UE is being transported by an aircraft in flight based on at least one of an altitude, an atmospheric pressure, or a speed that is measured by the UE. An emission restriction determiner determines whether to restrict emission of radio waves in a predetermined frequency band from the UE based on a result of the determination of whether the UE is being transported by an aircraft in flight.

### CROSS-REFERENCE TO RELATED APPLICATION

This application claims priority to JP 2025-068437, filed on Apr. 17, 2025; the entire contents of which are incorporated herein by reference.

### FIELD

The present disclosure relates to a restriction on emission of radio wave from communication terminal.

### BACKGROUND

In WO 2022/254744 A1, there is described a communication control apparatus which can effectively manage a connection authority of a communication device to a wireless communication system in which a terrestrial communication system and a non-terrestrial communication system coexist.

The information disclosed in this background section is only for enhancement of understanding of the general background of the disclosure and should not be taken as an acknowledgement or any form of suggestion that this information forms the prior art already known to a person skilled in the art.

### SUMMARY

As in a case in which a passenger of an aircraft carries a communication terminal, for example, a communication terminal is sometimes transported by an aircraft. Given that recent years have witnessed presence of communication terminals that are capable of direct communication with satellites as described in WO 2022/254744 A1, a communication terminal being transported by an aircraft sometimes emits radio waves for communication with a satellite even at a considerably high altitude and, depending on a frequency band of the radio waves, the radio waves may adversely affect instruments of the aircraft.

In addition, radio waves emitted from a communication terminal in the air tend to travel far and wide compared to radio waves from a communication terminal on the ground and, depending on the frequency band, may end up as noise in communication held on the ground.

Thus, emission of radio waves from a communication terminal being transported by an aircraft in flight is undesirable.

The present disclosure has been made in view of the above-mentioned circumstances, and has an object to restrict emission of radio waves in a predetermined frequency band from a communication terminal being transported by an aircraft during flight of the aircraft.

A communication terminal according to at least one embodiment of the present disclosure executes a determination process and an emission restriction determination process. In the determination process, whether the communication terminal is being transported by an aircraft in flight is determined based on at least one of an altitude, an atmospheric pressure, or a speed that is measured by the communication terminal. In the emission restriction determination process, whether to restrict emission of radio waves in a predetermined frequency band from the communication terminal is determined based on a result of the determination of whether the communication terminal is being transported by an aircraft in flight.

Further, an emission control method according to at least one embodiment of the present disclosure includes determining, by a communication terminal, whether the communication terminal is being transported by an aircraft in flight, based on at least one of an altitude, an atmospheric pressure, or a speed that is measured by the communication terminal. The emission control method also includes determining, by the communication terminal, whether to restrict emission of radio waves in a predetermined frequency band from the communication terminal, based on a result of the determination of whether the communication terminal is being transported by an aircraft in flight.

Further, an information storage medium according to at least one embodiment of the present disclosure is a non-transitory computer-readable information storage medium having stored thereon a program to be executed by a computer which is a communication terminal. The program causes the communication terminal to determine, based on at least one of an altitude, an atmospheric pressure, or a speed that is measured by the communication terminal, whether the communication terminal is being transported by an aircraft in flight. The program also causes the communication terminal to determine, based on a result of the determination of whether the communication terminal is being transported by an aircraft in flight, whether to restrict emission of radio waves in a predetermined frequency band from the communication terminal.

### BRIEF DESCRIPTION OF THE DRAWINGS

Features, aspects, and advantages of embodiments of the disclosure will be described below with reference to the accompanying drawings, in which like reference numerals denote like elements, and wherein:

FIG. 1 is a diagram for illustrating an example of an implementation environment in at least one embodiment of the present disclosure.

FIG. 2 is a functional block diagram for illustrating an example of functions implemented by a UE in the at least one embodiment of the present disclosure.

FIG. 3 is a flowchart for illustrating an example of a flow of processes performed by the UE in the at least one embodiment of the present disclosure.

FIG. 4 is a diagram for illustrating an example of a situation in which a UE in another embodiment of the present disclosure is mounted on an unmanned aircraft.

FIG. 5 is a diagram of example components of a device which is a UE.

### DETAILED DESCRIPTION

The following detailed description of example embodiments refers to the accompanying drawings. The present disclosure provides illustrations and descriptions, but is not intended to be exhaustive or to limit the implementations to the precise form disclosed. Modifications and variations are possible in light of the present disclosure or may be acquired from practice of the implementations. Further, one or more features or components of one embodiment may be incorporated into or combined with another embodiment (or one or more features of another embodiment). Additionally, the flowchart and description of operations provided below relate to at least one of the embodiments in the present disclosure. It should be noted that it is possible to make other embodiments that do not exactly match the flowchart and its description. It is understood that in other embodiments one or more operations may be omitted, one or more operations may be added, one or more operations may be performed simultaneously (at least in part).

It will be apparent that systems and/or methods, described herein, may be implemented in different forms of hardware, software, or a combination of hardware and software. The actual specialized control hardware or software code used to implement these systems and/or methods should not limit their implementations. Thus, the operation and behavior of the systems and/or methods are described herein without reference to specific software code. It is understood that software and hardware may be designed to implement the systems and/or methods based on the description herein.

Even though particular combinations of features are recited in the claims and/or disclosed in the specification, the particular combinations are not intended to limit the disclosure of implementations. In fact, many of these features may be combined in ways not specifically recited in the claims and/or disclosed in the specification. Even if a dependent claim directly depends on only one claim, the present disclosure may indicate that the dependent claim is dependent on other claims in the claim set.

No element, act, or instruction used herein should be construed as critical or essential unless explicitly described as such. Also, as used herein, the articles “a” and “an” (in other words, nouns not mentioned in the plural) are intended to include one or more items, and may be used interchangeably with “one or more.” Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B],” “[A] and/or [B],” or “at least one of [A] or [B]” are to be understood as including only A, only B, or both A and B.

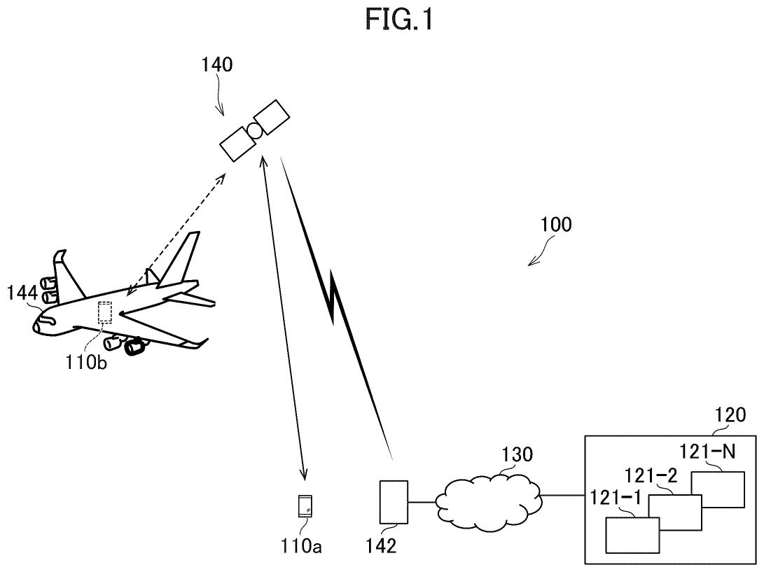

FIG. 1 is a diagram of an example of implementation environment 100 in which systems and/or method, described herein, may be implemented. The implementation environment 100 includes a UE (User equipment) 110, a service environment 120, and a network 130. The service environment 120 include one or more sub-environments 121. To illustrate this, FIG. 1 shows, for convenience, examples of a 1st sub-environment 121-1, a 2nd sub-environment 121-2, and an N-th sub-environment 121-N (where N is any natural number).

The UE 110 is connected to the network 130, and the network 130 is connected to the service environment 120. The connections may be wired, wireless, or a combination of both wired and wireless. The UE 110 and the service environment 120 are connected via the network 130.

The UE 110 is a device that communicates with the service environment 120. The UE 110 receives information from the service environment 120 and/or sends information to the service environment 120. Also, the UE 110 may generate and/or store information to be transmitted, as necessary. Also, the UE 110 may store and/or process information that is received, as necessary.

The example FIG. 1 refers to the “UE”. However, it should be understood by those skilled in the art that general terms such as “user device,” “terminal,” “terminal device,” “communication device,” and “communication terminal” can be used interchangeably with the term “UE.”

For example, the UE 110 may include a computing device (e.g., a desktop computer, a laptop computer, a tablet computer, a handheld computer, a smart speaker, a server, etc.), a mobile phone (e.g., a smart phone, a radiotelephone, etc.), a wearable device (e.g., a pair of smart glasses or a smart watch), or a similar device.

The service environment 120 is an environment that communicates with the UE 110 to provide one or more services. The service environment 120 receives information from the UE 110 and/or sends information to the UE 110. Also, the service environment 120 may generate and/or store information to be transmitted, as necessary. Also, the service environment 120 may store and/or process information that is received, as necessary. For example, the service environment 120 may provide computing resources as one of the services. It should be noted that the service is not limited to being provided to the UE; it may also be provided to devices other than the UE. For example, based on communication from the UE, the service may perform processes such as anomaly detection or traffic analysis and notify the results to a predetermined destination.

The example FIG. 1 refers to the “service environment”. The term “service environment” is used to refer to the broader context within which services operate. For example, cloud environments, platforms, computing systems, network systems, and cloud systems generally represent the environments in which services are conducted, and these are included within the “service environment.” However, the “service environment” is not limited to these examples. Additionally, the specific types of environments within the “service environment” are not restricted. For instance, cloud environments and cloud systems can be categorized as private cloud, public cloud, hybrid cloud, or multi-cloud, all of which are included within the “service environment.”

The one or more services provided by the service environment 120 is not specifically limited and can be adjusted according to the embodiments. For example, the services may include a service that provides information to the UE 110, a service that stores information from the UE 110, or a service that performs processing based on information from the UE 110 and returns the results of the processing.

In an embodiment, the Service Environments 120 may also provide computing resources as the service. The computing resources can be hardware resources and/or software resources. For example, applications, processors, memory, and storage can be included in the provided computing resources. Each computing resource can communicate with other computing resources via wired connections, wireless connections, or a combination of wired and wireless connections.

The provided computing resources can be actual resources (also referred to as physical resources) and/or virtual resources. Furthermore, means of virtualization for virtual resources can be selected as appropriate. That is, in this disclosure, the use of adjectives such as “Virtual” or “Virtualized” to describe names does not imply that they are virtualized by a specific means of virtualization. For example, “virtual machine” refers to software that operates like an actual computer, realized through means of virtualization, and it is not intended to exclude those realized by specific means of virtualization such as Hypervisors or Containers. Conversely, when means of virtualization such as Hypervisors or containers are mentioned in this disclosure, it is merely cited as a general method of implementation. It should also be interpreted that embodiments implemented with other virtualization means are also disclosed. Also, the services may also be provided using resources virtualized by different means.

The service environment 120 includes one or more devices, such as servers and network devices, which provide services or perform processes. The placement of these devices within the service environment 120 can be determined as appropriate. Additionally, if the service environment 120 includes one or more sub-environments 121, the placement of devices can be determined based on predetermined policies for each sub-environment 121. For example, devices related to the first service may be placed in the 1st sub-environment 121-1, and devices related to the second service may be placed in the 2nd sub-environment 121-2. In another example, devices expected to have a higher load than a predetermined threshold may be placed in the 1st sub-environment 121-1, while devices expected to have a lower load than the predetermined threshold may be placed in the 2nd sub-environment 121-2. In this way, specific devices can be placed in specific sub-environments 121. Conversely, each sub-environment 121 can be specialized for a particular purpose.

In an embodiment, all processes executed in a single service may run within a single service environment, or in multiple service environments. Multiple processes executed in a single service could be provided by different service environments.

The network 130 is a network that exchanges information between the UE 110 and the service environment 120. The network 130 includes one or more wired and/or wireless networks.

For example, the network 130 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, a non-terrestrial network (NTN), and/or a combination of these or other types of networks.

The network 130 can be a part of a network. For example, in a 5G network that includes a RAN, a transport network, and a core network, the network 130 can be at least one of the RAN, the transport network, or the core network. For example, the service environment 120 could be in the core network, in which case the network 130 could correspond to a network that is a combination of a RAN and a transport network and is part of the 5G network.

The number and arrangement of devices and networks shown in FIG. 1 are provided as an example. It should be understood that any changes that may be implemented by those skilled in the art, such as the addition or rearrangement of well-known devices or networks at the time of implementation, are included in this disclosure.

The implementation environment 100 illustrated in FIG. 1 is now further described.

In FIG. 1, a UE 110a and a UE 110b are illustrated as UEs 110 included in the implementation environment 100 in at least one embodiment of the present disclosure. The UE 110a and the UE 110b are assumed to be communication terminals capable of wireless communication via a satellite as well as wireless communication via a ground antenna. In the at least one embodiment, wireless communication via a satellite is performed by using, for example, the same protocol as that of wireless communication via a ground antenna.

In the at least one embodiment, the UE 110a located within a communication range of a satellite 140 communicates with the service environment 120 via the satellite 140, a terrestrial gateway device 142, and the network 130. The UE 110a is assumed to be carried by a user on the ground.

As illustrated in FIG. 1, it is assumed that the UE 110b is carried by, for example, a passenger of an aircraft 144 and is being transported by the aircraft 144. When the UE 110b emits radio waves in response to a broadcast signal transmitted from the satellite 140 in this situation, depending on a frequency band of the radio waves, the radio waves may adversely affect instruments of the aircraft 144.

In addition, radio waves emitted from the UE 110b in the air as illustrated in FIG. 1 tend to travel far and wide compared to radio waves from the UE 110a on the ground and, depending on the frequency band, may end up as noise in communication performed on the ground.

Thus, emission of radio waves from the UE 110 (the UE 110b in the example of FIG. 1) being transported by the aircraft 144 in flight is undesirable.

In light of this, in the at least one embodiment, the following measure is taken to restrict emission of radio waves in a predetermined frequency band (for example, radio waves in a frequency band used for wireless communication via the satellite 140) from the UE 110 that is being transported by the aircraft 144 during flight of the aircraft 144.

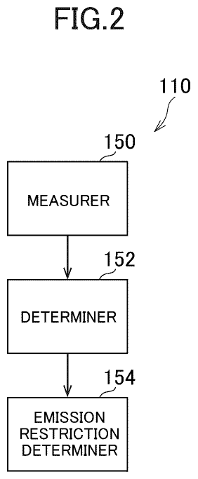

FIG. 2 is a functional block diagram for illustrating an example of functions implemented in the UE 110 in the at least one embodiment of the present disclosure. It is not required for all of the functions illustrated in FIG. 2 to be implemented in the UE 110 in the at least one embodiment, and functions other than those illustrated in FIG. 2 may be implemented.

As illustrated in FIG. 2, the UE 110 in the at least one embodiment functionally includes, for example, a measurer 150, a determiner 152, and an emission restriction determiner 154.

The functions illustrated in FIG. 2 may be implemented by executing, by a processor included in the UE 110, a program that is installed in the UE 110, and that includes instructions corresponding to the functions. The program may be supplied to the UE 110 via a computer-readable information storage medium, such as an optical disc, a magnetic disk, a magnetic tape, a magneto-optical disc, a flash memory, or the like, or via the Internet or the like. The functions illustrated in FIG. 2 may also be implemented by a circuit block, a memory, and other LSIs. Further, a person skilled in the art would understand that the functions illustrated in FIG. 2 can be implemented in various forms by only hardware, by only software, or by a combination of hardware and software. Further, the functions illustrated in FIG. 2 may be implemented as one function of system software (for example, an operating system (OS)) installed in the UE 110. Further, the functions illustrated in FIG. 2 may be implemented in an application program installed in the UE 110. Further, the functions illustrated in FIG. 2 may be implemented in a network interface included in the UE 110.

The measurer 150 included in the UE 110 measures, in the at least one embodiment, for example, at least one of an altitude, an atmospheric pressure, or a speed. The function of the measurer 150 may be implemented by a measurement device included in the UE 110.

For example, the UE 110 may include a height indicator. The height indicator may measure the altitude. The UE 110 may include a barometer. The barometer may measure the atmospheric pressure. The UE 110 may include a speed meter. The speed meter may measure the speed. The UE 110 may include a positioning receiver, such as a global positioning system (GPS) receiver or a Global Navigation Satellite System (GNSS) receiver, which receives a positioning signal. The positioning receiver may measure at least one of latitude, longitude, an altitude, or a speed.

The determiner 152 in the at least one embodiment determines whether or not the UE 110 is being transported by the aircraft 144 in flight, based on, for example, at least one of the altitude, the atmospheric pressure, or the speed that is measured by the UE 110.

The emission restriction determiner 154 in the at least one embodiment determines whether or not to restrict emission of radio waves in a predetermined frequency band (for example, radio waves in the frequency band used for wireless communication via the satellite 140) from the UE 110, based on, for example, a result of the determination of whether or not the UE 110 is being transported by the aircraft 144 in flight.

The emission restriction determiner 154 may restrict emission of radio waves in the predetermined frequency band (for example, radio waves in the frequency band used for wireless communication via the satellite 140) from the UE 110 when, for example, it is determined that the UE 110 is being transported by the aircraft 144 in flight.

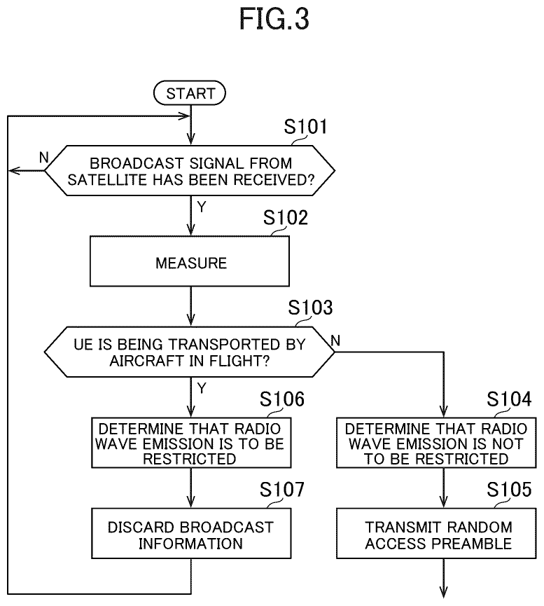

An example of a flow of processes performed by the UE 110 in the at least one embodiment is now described with reference to a flowchart illustrated as an example in FIG. 3.

First, the UE 110, which is in a radio resource control (RRC) idle state, waits to receive a broadcast signal (for example, a system information block (SIB)) from the satellite 140 (Step S101).

When the UE 110 receives the broadcast signal, the measurer 150 executes measurement (Step S102).

The determiner 152 then determines, based on a result of the measurement in the process step of Step S102, whether or not the UE 110 is being transported by the aircraft 144 in flight (Step S103).

When it is determined in the process step of Step S103 that the UE 110 is not being transported by the aircraft 144 in flight (Step S103: N), the emission restriction determiner 154 determines that emission of radio waves in the predetermined frequency band from the UE 110 is not to be restricted (Step S104), and the UE 110 accordingly transmits a random access preamble (RACH preamble) (Step S105). Step S105 is followed by continued execution of a process for establishing connection between the UE 110 and a base station (eNodeB). In this case, emission of radio waves in the frequency band used for wireless communication via the satellite 140 is not restricted.

When it is determined in the process step of Step S103 that the UE 110 is being transported by the aircraft 144 in flight (Step S103: Y), on the other hand, the emission restriction determiner 154 determines that emission of radio waves in the predetermined frequency band from the UE 110 is to be restricted (Step S106), and discards broadcast information which is indicated by the broadcast signal received in the process step of Step S101 (Step S107). The process then returns to the process step of Step S101. In this case, emission of radio waves in the frequency band used for wireless communication via the satellite 140 is restricted.

As described above, the determiner 152 may determine whether or not the UE 110 is being transported by the aircraft 144 in flight in response to the reception of the broadcast signal from the satellite 140.

The measurement device included in the UE 110 may measure at least one of the altitude, the atmospheric pressure, or the speed in response to the reception of the broadcast signal from the satellite 140.

The emission restriction determiner 154 may determine whether or not to restrict transmission of the random access preamble.

The altitude may be measured in the process step of Step S102. In this case, in the process step of Step S103, the determiner 152 may determine that the UE 110 is being transported by the aircraft 144 in flight when the measured altitude is equal to or more than a given threshold value (for example, 10,000 meters). The determiner 152 may determine that the UE 110 is not being transported by the aircraft 144 in flight when the measured altitude is less than a given threshold value (for example, 10,000 meters).

The atmospheric pressure may be measured in the process step of Step S102. In this case, in the process step of Step S103, the determiner 152 may determine that the UE 110 is being transported by the aircraft 144 in flight when the measured atmospheric pressure is equal to or less than a given threshold value (for example, 0.85 atm). The determiner 152 may determine that the UE 110 is not being transported by the aircraft 144 in flight when the measured atmospheric pressure is more than a given threshold value (for example, 0.85 atm). Although an interior of the aircraft 144 is pressurized by pressurization equipment, the atmospheric pressure in the interior of the aircraft 144 in level flight is still lower than the atmospheric pressure in the interior of the aircraft 144 on the ground. Accordingly, by setting an appropriate threshold value, whether or not the UE 110 is being transported by the aircraft 144 in flight can accurately be determined based on the measured atmospheric pressure.

The speed may be measured in the process step of Step S102. In this case, in the process step of Step S103, the determiner 152 may determine that the UE 110 is being transported by the aircraft 144 in flight when the measured speed is equal to or more than a given threshold value (for example, 850 kilometers per hour). The determiner 152 may determine that the UE 110 is not being transported by the aircraft 144 in flight when the measured speed is less than a given threshold value (for example, 850 kilometers per hour).

In the example given above, determination of whether or not the UE 110 is being transported by the aircraft 144 in flight is based on one of the altitude, the atmospheric pressure, and the speed. However, determination of whether or not the UE 110 is being transported by the aircraft 144 in flight may be based on two or more out of the altitude, the atmospheric pressure, and the speed.

For example, the altitude and the speed may be measured in the process step of Step S102. In this case, in the process step of Step S103, the determiner 152 may determine that the UE 110 is being transported by the aircraft 144 in flight when the measured altitude is equal to or more than a given threshold value (for example, 10,000 meters) and the measured speed is equal to or more than a given threshold value (for example, 850 kilometers per hour). The determiner 152 may determine that the UE 110 is not being transported by the aircraft 144 in flight when at least one of a condition that the measured altitude is less than a given threshold value (for example, 10,000 meters) or a condition that the measured speed is less than a given threshold value (for example, 850 kilometers per hour) is satisfied.

The atmospheric pressure and the speed may be measured in the process step of Step S102. In this case, in the process step of Step S103, it may be determined that the UE 110 is being transported by the aircraft 144 in flight when the measured atmospheric pressure is equal to or less than a given threshold value (for example, 0.85 atm) and the measured speed is equal to or more than a given threshold value (for example, 850 kilometers per hour). The determiner 152 may determine that the UE 110 is not being transported by the aircraft 144 in flight when at least one of a condition that the measured atmospheric pressure is more than a given threshold value (for example, 0.85 atm) or a condition that the measured speed is less than a given threshold value (for example, 850 kilometers per hour) is satisfied.

In the at least one embodiment, execution of measurement of at least one of the altitude, the atmospheric pressure, or the speed in response to the reception of the broadcast signal from the satellite 140 is not a requirement. Also, execution of determination of whether or not the UE 110 is being transported by the aircraft 144 in flight in response to the reception of the broadcast signal from the satellite 140 is not a requirement. For example, in the UE 110 performing communication, the measurement by the measurer 150, the determination by the determiner 152, and the determination by the emission restriction determiner 154 may be executed repeatedly at predetermined time intervals. The UE 110 may be designed so as to, when it is subsequently determined in the UE 110 that emission of radio waves in the predetermined frequency band is to be restricted, avoid emission of radio waves in the predetermined frequency band from the UE 110 by cutting the communication that has been performed by the UE 110.

As described above, in the at least one embodiment, whether or not the UE 110 is being transported by the aircraft 144 in flight is determined based on at least one of the altitude, the atmospheric pressure, or the speed that is measured by the UE 110. Whether or not to restrict emission of radio waves in predetermined frequency band from the UE 110 is then determined based on a result of the determination of whether or not the UE 110 is being transported by the aircraft 144 in flight.

In this manner, according to the at least one embodiment, emission of radio waves in a predetermined frequency band from the UE 110 being transported by the aircraft 144 can be restricted during flight of the aircraft 144.

The determiner 152 may store three-dimensional world map data. Then the determiner 152 may identify an elevation of the ground level at a geographical point identified by a combination of latitude and longitude that are measured by the GPS. The determiner 152 may determine that the UE 110 is being transported by the aircraft 144 in flight in a case in which a difference between the altitude measured by the GPS or the height indicator and the identified elevation is equal to or more than a predetermined threshold value. The determiner 152 may otherwise determine that the UE 110 is not being transported by the aircraft 144 in flight.

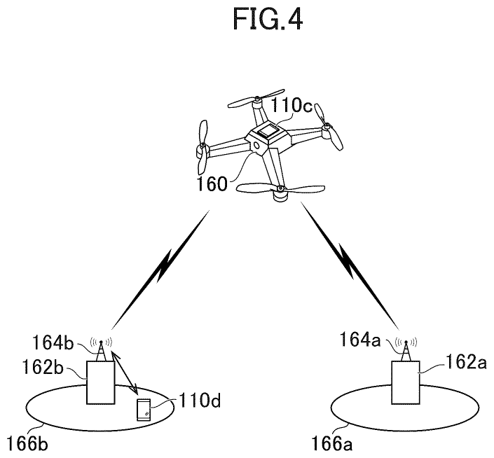

FIG. 4 is a diagram for illustrating an example of a situation in which a UE 110c in another embodiment of the present disclosure is mounted on an unmanned aircraft (unmanned aerial vehicle: UAV) 160 such as a drone.

A ground communication facility 162a, a ground antenna 164a, a cell 166a, a ground communication facility 162b, a ground antenna 164b, and a cell 166b are illustrated in FIG. 4. A UE 110d located within a range of the cell 166b is illustrated in FIG. 4 as well. The UE 110d is assumed to be carried by a user on the ground.

It is assumed that the ground communication facility 162a and the ground communication facility 162b include the ground antenna 164a and the ground antenna 164b, respectively. The cell 166a is assumed to be a communication range (coverage) of the ground antenna 164a, and the cell 166b is assumed to be a communication range (coverage) of the ground antenna 164b. As illustrated in FIG. 4, the cell 166a and the cell 166b are distanced from each other. It is also assumed that the same frequency band is used for wireless communication performed via the ground antenna 164a and wireless communication performed via the ground antenna 164b.

In this situation, radio waves emitted from the UE 110c in the air tend to travel far and wide compared to radio waves from the UE 110d on the ground and, depending on the frequency band, may end up as noise in communication performed on the ground. For example, when the UE 110c mounted on the unmanned aircraft 160 communicates with the ground antenna 164a, radio waves emitted from the UE 110c may, depending on a frequency band of the radio waves, end up as noise in communication performed between the UE 110d located within the range of the cell 166b and the ground antenna 164b.

The technology described above with reference to FIG. 1 to FIG. 3 may be applied to the UE 110c illustrated in FIG. 4. That is, whether or not the UE 110c is being transported by the unmanned aircraft 160 in flight may be determined based on at least one of the altitude, the atmospheric pressure, or the speed that is measured by the UE 110c illustrated in FIG. 4. Whether or not to restrict emission of radio waves in a predetermined frequency band from the UE 110c may then be determined based on a result of the determination of whether or not the UE 110c is being transported by the unmanned aircraft 160 in flight.

In this manner, emission of radio waves in a predetermined frequency band from the UE 110 (the UE 110c in the example of FIG. 4) being transported by the unmanned aircraft 160 can be restricted during flight of the unmanned aircraft 160.

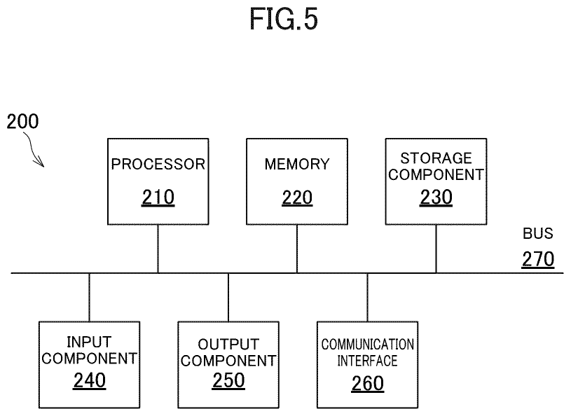

FIG. 5 illustrates an embodiment of a device 200 which is a UE 110. As shown in FIG. 5, the device 200 includes processor 210, a memory 220, a storage component 230, an input component 240, an output component 250, a communication interface 260, and a bus 270.

The processor 210, as used herein, means any type of computational circuit that may comprise hardware elements and software elements. The processor 210 may be embodied as a multi-core processor, a single core processor, or a combination of one or more multi-core processors and/or one or more single core processors, a distributed processing system, or the like. The processor 210 may be a Central Processing Unit (CPU), a graphics processing unit (GPU), an accelerated processing unit (APU), an application-specific integrated circuit (ASIC), or another type of processing component.

Memory 220 includes a non-transitory computer readable medium. Memory 220 includes a random-access memory (RAM), a read only memory (ROM), and/or another type of dynamic or static storage device (e.g., a flash memory, a magnetic memory, and/or an optical memory) that stores information and/or instructions for use by processor 210. The memory 220 comprises machine-readable instructions which are executable by the processor 210. These machine-readable instructions when executed by the processor 210 cause the processor 210 to perform one or more method steps of an embodiment described above.

Storage component 230 stores information and/or software related to the operation and use of the device 200. For example, storage component 230 may include a hard disk (e.g., a magnetic disk, an optical disk, a magneto-optic disk, and/or a solid-state disk), a compact disc (CD), a digital versatile disc (DVD), a floppy disk, a cartridge, a magnetic tape, and/or another type of non-transitory computer-readable medium, along with a corresponding drive.

Input component 240 is configured to receive information, such as user input. For example, the input component 240 may include, but not be limited to, a touch screen display, a keyboard, a keypad, a mouse, a button, a switch, and/or a microphone. Additionally, or alternatively, the input component 240 may include a sensor for sensing information (e.g., a global positioning system (GPS), an accelerometer, a gyroscope, and/or an actuator).

Output component 250 is configured to provide output information from the device 200. For example, the output component 250 may be, but not limited to, a display, a speaker, an instruction device to an external device, and/or one or more light-emitting diodes (LEDs).

Communication interface 260 is an interface that provides a communication connection to other devices, such as external devices and internal devices. The connection by the communication interface 260 can be a wired connection, a wireless connection, or a combination of wired and wireless connections, and can be a direct connection or an indirect connection via a communication network that exists between the device 200 and other devices. In other words, the standard of the communication interface 260 is not limited.

The bus 270 acts as an interconnect between the processor 210, the memory 220, the storage component 230, the input component 240, the output component 250, and the communication interface 260 of the device 200. The bus 270 may include a wired interconnection or a wireless interconnection.

The number and arrangement of components shown in FIG. 5 are provided as an example. In practice, device 200 may include additional components, fewer components, different components, or differently arranged components than those shown in FIG. 5. Additionally, or alternatively, a set of components (e.g., one or more components) of device 200 may perform one or more functions described as being performed by another set of components of device 200. Further, one or more method steps described in any of the embodiments may be performed utilizing a plurality of devices 200 in communication with one another.

The above-mentioned measurement device may be included in the input component 240.

The technology described in the present disclosure can also be expressed as follows.
[1] A communication terminal, including:
determination means for determining, based on at least one of an altitude, an atmospheric pressure, or a speed that is measured by the communication terminal, whether the communication terminal is being transported by an aircraft in flight; and
emission restriction determination means for determining, based on a result of the determination of whether the communication terminal is being transported by an aircraft in flight, whether to restrict emission of radio waves in a predetermined frequency band from the communication terminal.
[2] The communication terminal according to Item [1],
wherein the communication terminal is a communication terminal that performs wireless communication via a satellite, and
wherein the emission restriction determination means is configured to determine whether to restrict emission of radio waves from the communication terminal in a frequency band used for the wireless communication via the satellite.
[3] The communication terminal according to Item [2], wherein the determination means is configured to determine whether the communication terminal is being transported by an aircraft in flight in response to reception of a broadcast signal from the satellite.
[4] The communication terminal according to Item [2], further including a measurement device which measures at least one of an altitude, an atmospheric pressure, or a speed,
wherein the measurement device measures the at least one of the altitude, the atmospheric pressure, or the speed in response to reception of a broadcast signal from the satellite, and
wherein the determination means is configured to determine whether the communication terminal is being transported by an aircraft in flight based on the at least one of the altitude, the atmospheric pressure, or the speed that is measured by the measurement device.
[5] The communication terminal according to Item [1], wherein the emission restriction determination means is configured to determine whether to restrict transmission of a random access preamble.
[6] An emission control method, including:
determining, by a communication terminal, whether the communication terminal is being transported by an aircraft in flight, based on at least one of an altitude, an atmospheric pressure, or a speed that is measured by the communication terminal; and
determining, by the communication terminal, whether to restrict emission of radio waves in a predetermined frequency band from the communication terminal, based on a result of the determination of whether the communication terminal is being transported by an aircraft in flight.
[7] A program for causing a communication terminal, which is a computer, to:
determine, based on at least one of an altitude, an atmospheric pressure, or a speed that is measured by the communication terminal, whether the communication terminal is being transported by an aircraft in flight; and
determine, based on a result of the determination of whether the communication terminal is being transported by an aircraft in flight, whether to restrict emission of radio waves in a predetermined frequency band from the communication terminal.

While there have been described what are at present considered to be certain embodiments of the invention, it will be understood that various modifications may be made thereto, and it is intended that the appended claims cover all such modifications as fall within the true spirit and scope of the invention.

What is claimed is:

1. A communication terminal which executes:
a determination process of determining, based on at least one of an altitude, an atmospheric pressure, or a speed that is measured by the communication terminal, whether the communication terminal is being transported by an aircraft in flight; and
an emission restriction determination process of determining, based on a result of the determination of whether the communication terminal is being transported by an aircraft in flight, whether to restrict emission of radio waves in a predetermined frequency band from the communication terminal.

2. The communication terminal according to claim 1,
wherein the communication terminal is a communication terminal that performs wireless communication via a satellite, and
wherein the emission restriction determination process includes determining whether to restrict emission of radio waves from the communication terminal in a frequency band used for the wireless communication via the satellite.

3. The communication terminal according to claim 2, wherein the determination process includes determining whether the communication terminal is being transported by an aircraft in flight in response to reception of a broadcast signal from the satellite.

4. The communication terminal according to claim 2, further comprising a measurement device which measures at least one of an altitude, an atmospheric pressure, or a speed,
wherein the measurement device measures the at least one of the altitude, the atmospheric pressure, or the speed in response to reception of a broadcast signal from the satellite, and
wherein the determination process includes determining whether the communication terminal is being transported by an aircraft in flight based on the at least one of the altitude, the atmospheric pressure, or the speed that is measured by the measurement device.

5. The communication terminal according to claim 1, wherein the emission restriction determination process includes determining whether to restrict transmission of a random access preamble.

6. An emission control method, comprising:
determining, by a communication terminal, whether the communication terminal is being transported by an aircraft in flight, based on at least one of an altitude, an atmospheric pressure, or a speed that is measured by the communication terminal; and
determining, by the communication terminal, whether to restrict emission of radio waves in a predetermined frequency band from the communication terminal, based on a result of the determination of whether the communication terminal is being transported by an aircraft in flight.

7. A non-transitory computer-readable information storage medium having stored thereon a program, the program causing a computer, which is a communication terminal, to:
determine, based on at least one of an altitude, an atmospheric pressure, or a speed that is measured by the communication terminal, whether the communication terminal is being transported by an aircraft in flight; and
determine, based on a result of the determination of whether the communication terminal is being transported by an aircraft in flight, whether to restrict emission of radio waves in a predetermined frequency band from the communication terminal.
